(19) United States
(12) Patent Application Publication
(10) Pub. No.: US 2024/0212006 A1
(43) Pub. Date: Jun. 27, 2024

(54) METHODS AND SYSTEMS FOR TRACKING AND RECOMMENDING SERVICE PROVIDERS

(71) Applicant: TREGAN LLC, Stafford, VA (US)

(72) Inventor: Troy Patrick BINKLEY, Stafford, VA (US)

(21) Appl. No.: 18/390,557

(22) Filed: Dec. 20, 2023

Related U.S. Application Data
(60) Provisional application No. 63/434,215, filed on Dec. 21, 2022.

(51) Int. Cl. G06Q 30/0282; G06Q 30/02

(52) U.S. Cl. CPC G06Q 30/0282; G06Q 30/0281

(57) ABSTRACT

Systems, methods, apparatuses, and computer program products for tracking and recommending service providers. The method may include receiving, by a computing device, a first rating associated with a service provider at a first service location from a first user device, storing, by the computing device, the first rating in a profile associated with the service provider, and updating an overall rating of the profile associated with the service provider based on the first rating, determining, by the computing device, that the overall rating satisfies at least one first threshold, and transmitting by the computing device, a recommendation to a second user device based on the overall rating satisfying the at least one first threshold.

### CROSS-REFERENCE TO RELATED APPLICATION

This application claims the benefit of U.S. Provisional Patent Application No. 63/434,215, filed Dec. 21, 2022, which is herein incorporated by reference in its entirety.

### FIELD

Some example embodiments may generally relate to mobile technologies and information sharing. For example, certain example embodiments may relate to apparatuses, systems, and/or methods for tracking and recommending service providers.

### BACKGROUND

Examples of mobile technologies and information sharing include websites and mobile applications for rating restaurants, bars, salons, vehicle repair and body shops, and other service locations. These websites and applications focus on the service location, but do not provide sufficient information on the actual point of contact, the servicing individual (i.e., human service provider). Even if a service provided is mentioned in a review, it may be unknown whether the servicing individual is still working at the service location, and when the servicing individual is available.

### SUMMARY

An embodiment may be directed to an apparatus. The apparatus may include at least one processor and at least one memory storing instructions. The instructions stored in the at least memory, when executed by the at least one processor, may cause the apparatus at least to receive a first rating associated with a service provider at a first service location from a first user device; store the first rating in a profile associated with the service provider; update an overall rating of the profile associated with the service provider based on the first rating; determine that the overall rating satisfies at least one first threshold; and transmit a recommendation to a second user device based on the overall rating satisfying the at least one first threshold.

An embodiment may be directed to a method. The method can include receiving, by a computing device, a first rating associated with a service provider at a first service location from a first user device; storing, by the computing device, the first rating in a profile associated with the service provider; updating, by the computing device, an overall rating of the profile associated with the service provider based on the first rating; determining, by the computing device, that the overall rating satisfies at least one first threshold; and transmitting, by the computing device, a recommendation to a second user device based on the overall rating satisfying the at least one first threshold.

Another embodiment may be directed to an apparatus. The apparatus may include means for receiving a first rating associated with a service provider at a first service location from a first user device; means for storing the first rating in a profile associated with the service provider; means for updating an overall rating of the profile associated with the service provider based on the first rating; means for determining that the overall rating satisfies at least one first threshold; and means for transmitting a recommendation to a second user device based on the overall rating satisfying the at least one first threshold.

Another embodiment may be directed to an apparatus comprising receiving circuitry configured to receive a first rating associated with a service provider at a first service location from a first user device; storing circuitry configured to store the first rating in a profile associated with the service provider; updating circuitry configured to update an overall rating of the profile associated with the service provider based on the first rating; determining circuitry configured to determine that the overall rating satisfies at least one first threshold; and transmitting circuitry configured to transmit a recommendation to a second user device based on the overall rating satisfying the at least one first threshold.

Another embodiment may be directed to a non-transitory computer readable medium comprising program instructions stored thereon that, when executed by an apparatus, cause the apparatus to perform at least a method. The method can include receiving a first rating associated with a service provider at a first service location from a first user device; storing the first rating in a profile associated with the service provider; updating an overall rating of the profile associated with the service provider based on the first rating; determining that the overall rating satisfies at least one first threshold; and transmitting a recommendation to a second user device based on the overall rating satisfying the at least one first threshold.

### BRIEF DESCRIPTION OF THE DRAWINGS

For proper understanding of example embodiments, reference should be made to the accompanying drawings, wherein:

FIG. 1 illustrates an example first graphical user interface of an application, according to certain example embodiments;

FIG. 2 illustrates an example second graphical user interface of the application, according to some example embodiments;

FIG. 3 illustrates an example third graphical user interface of the application, according to various example embodiments;

FIG. 4 illustrates an example fourth graphical user interface of the application, according to certain example embodiments;

FIG. 5 illustrates an example fifth graphical user interface of the application, according to some example embodiments;

FIG. 6 illustrates an example sixth graphical user interface of the application, according to various example embodiments;

FIG. 7 illustrates an example seventh graphical user interface of the application, according to certain example embodiments.

FIG. 8 illustrates an example eighth graphical user interface of the application, according to some example embodiments;

FIG. 9 illustrates an example ninth graphical user interface of the application, according to various example embodiments;

FIG. 10 illustrates an example flow chart for a service provider, according to certain example embodiments;

FIG. 11 illustrates another example flow chart for a service provider, according to some example embodiments;

FIG. 12 illustrates an example flow chart for a guest, according to various example embodiments;

FIG. 13 illustrates another example flow chart for a guest, according to certain example embodiments;

FIG. 14 illustrates an example flow chart for a service location, according to some example embodiments;

FIG. 15 illustrates another example flow chart for a service location, according to various example embodiments;

FIG. 16 illustrates a set of apparatuses, according to certain example embodiments; and

FIG. 17 illustrates an example flow chart of operations performed by a computing device.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for tracking and recommending service providers.

The features, structures, or characteristics of example embodiments described throughout this specification may be combined in any suitable manner in one or more example embodiments. For example, the usage of the phrases “certain embodiments,” “an example embodiment,” “various embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Certain example embodiments described herein may have various benefits and/or advantages to overcome the disadvantages described above. For example, certain example embodiments may allow for recommendations of service locations and service providers to be made based on the location of the user device in combination with the performance of the service providers who are currently clocked in. Thus, certain example embodiments discussed below are directed to improvements in computer-related technology.

A mobile application (application), website, or other method of electronic communication may be used to track and recommend service providers. As an example, a mobile application will be described below, though the description applies to other electronic services as well. A service provider may be a waiter, bar tender, technician, esthetician, barber, electrician, plumber, or other person who provides a service to a customer (guest). The service provider may provide services to guests at a service location. A service location may be any of a restaurant, car garage, salon, bar, shop, etc. Guests may provide ratings and other feedback of the service provider's service in the application. The application may also provide recommendations to guests based on the ratings of the service provider and the service provider's availability status. The recommendation may include the service provider's name and description/picture as well as the service location and information on services at the service location. The application may be managed by a server or group of servers (such as a cloud web service) which may communicate with electronic devices (such as a mobile device, computer, tablet, or other electronic device) over one or more networks, such as mobile networks and/or wireless local area networks.

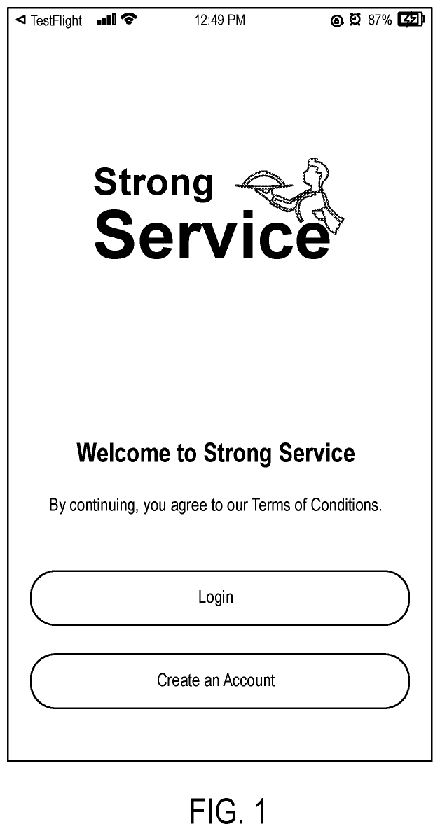

FIGS. 1-9 illustrate example graphical user interfaces from the application. The example graphical user interfaces display some of the features of the application. Each graphical user interface may be displayed on a display of a mobile device, computer, tablet, or other electronic device. FIG. 1 illustrates an example first graphical user interface of an application, according to certain example embodiments. The first graphical user interface may display a log in prompt configured for the application. The login may be for a guest, service provider, or service location.

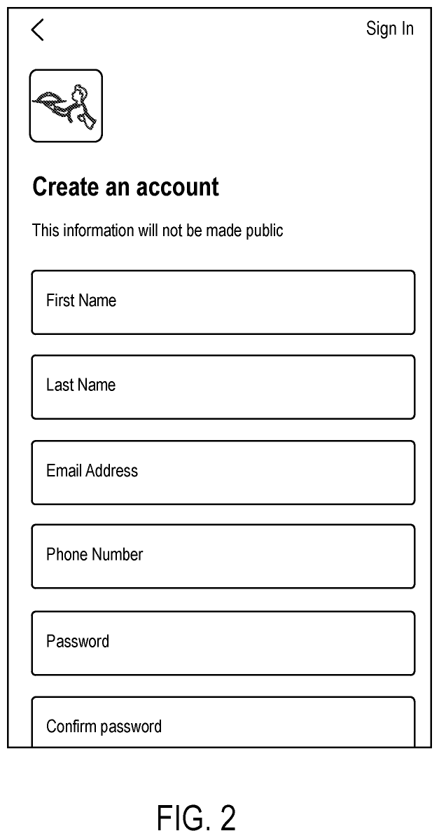

FIG. 2 illustrates an example second graphical user interface of the application, according to certain example embodiments. The second graphical user interface may be configured for creating an account, and may be accessed by selecting the “Create an Account” option on the first graphical user interface. The user of the application (guest, service provider, or service location representative) may enter information to create an account.

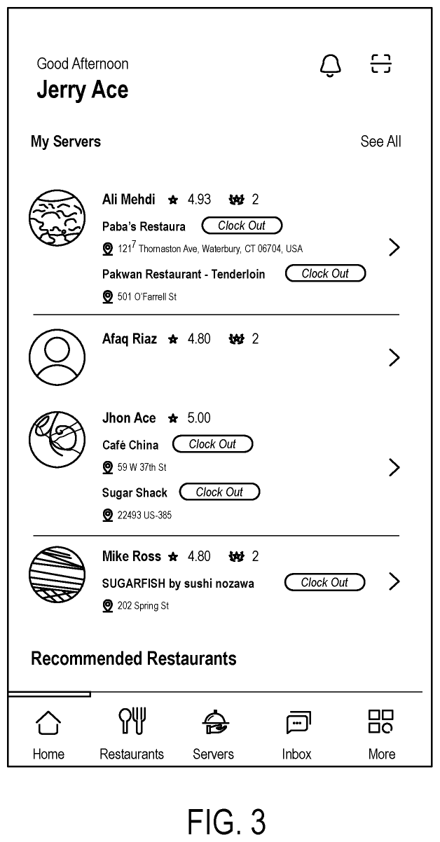

FIG. 3 illustrates an example third graphical user interface of the application, according to certain example embodiments. The third graphical user interface may be a home screen of the application for a guest with one or more service providers listed which the guest has already followed. The home screen may also display options that may be selected for displaying restaurants, servers, messages in an inbox, and additional options. The home screen may be displayed after the user has created an account and logged in.

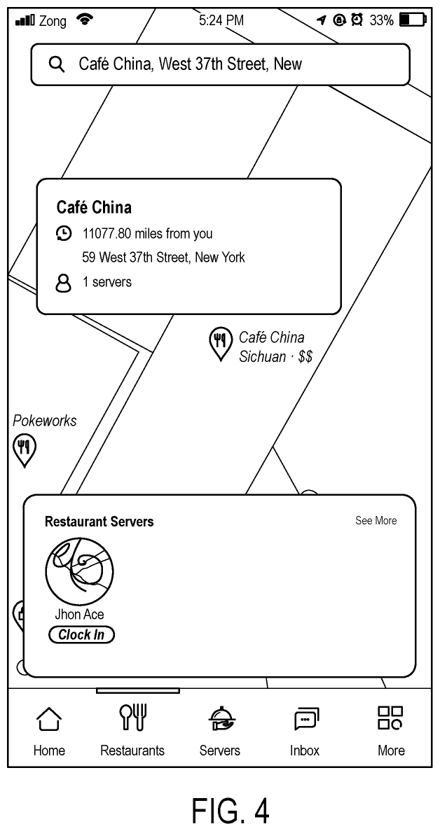

FIG. 4 illustrates an example fourth graphical user interface of the application, according to certain example embodiments. The fourth graphical user interface may be a restaurant screen with a map showing the location of a restaurant (or other service location) with at least one service provider also displayed. The displayed restaurant and service provider may be a recommendation provided by the application. The recommendation may be provided based on the service location having a highly rated service provider currently “clocked in” (e.g., available to serve guests).

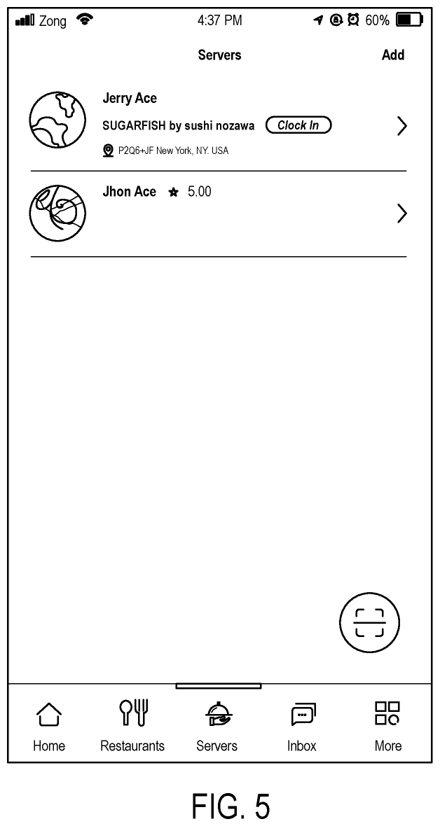

FIG. 5 illustrates an example fifth graphical user interface of the application, according to certain example embodiments. The fifth graphical user interface may be a server screen of the application which may display a list of servers which are recommended by the application or which the guest is already following.

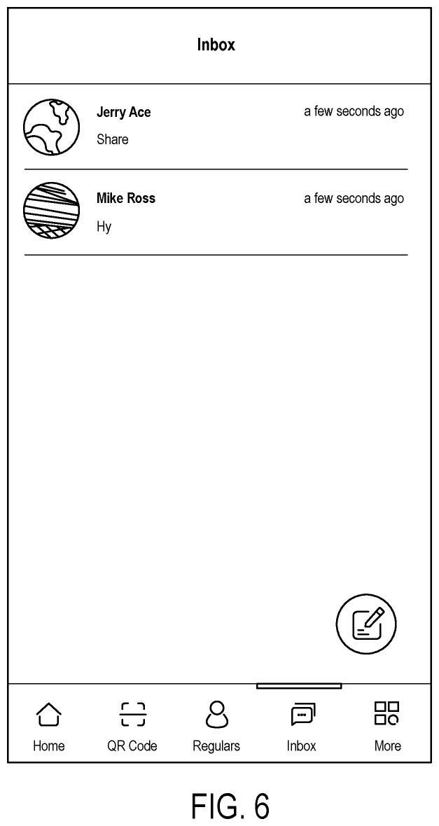

FIG. 6 illustrates an example sixth graphical user interface of the application, according to certain example embodiments. The sixth graphical user interface may be a message screen of the application, in which users can see messages. Service providers may send messages to guests that follow the service provider or guests which are regulars of the service provider. A regular may be following the service provider and has reached a threshold of services provided to the guest. For example, the guest may be a regular if the guest has followed the service provider on the application and the guest has received service from the service provider a threshold number of time (e.g., 5 times) within a threshold period of time (e.g., the last 60 days). A guest may be following a service when a request to follow (e.g., an indication to receive information related to the service provider) is received by a computing device managing the mobile application.

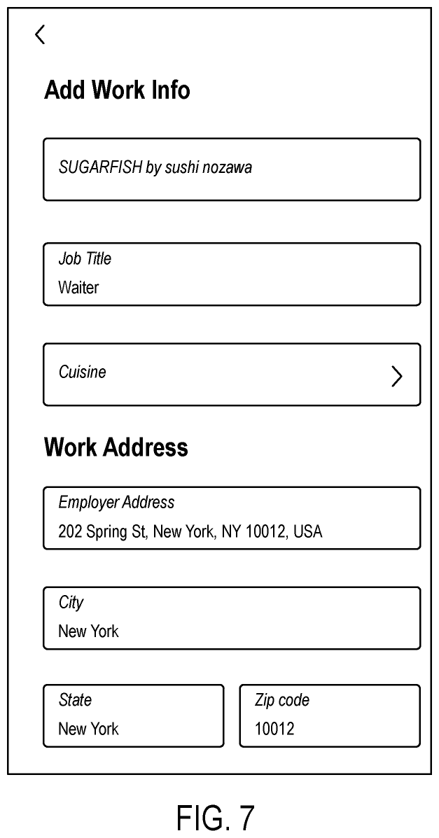

FIG. 7 illustrates an example seventh graphical user interface of the application, according to certain example embodiments. The seventh graphical user interface may be a service location screen for a service provider of the application. The service provider may enter the service location where the service provider works. The service provider may also enter work title, type of service, and address of the service location.

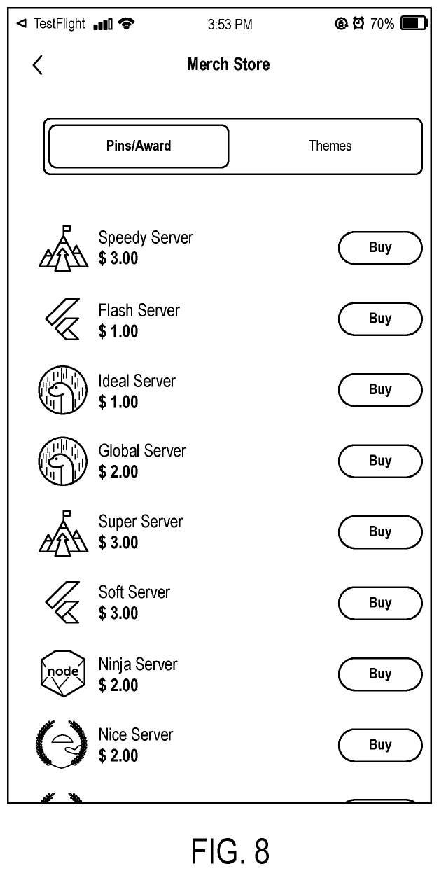

FIG. 8 illustrates an example eighth graphical user interface of the application, according to certain example embodiments. The eighth graphical user interface may be a merchandise ‘merch’ store of the application. Service locations, service providers, and guests may purchase pins and other items for their profile in the merchandise store. Some pins and other items may only be available if certain criteria have been met. For example, a speedy server pin may only be available if a guest gives a review/feedback indicating they received speedy service from the service provider. Other items may also be purchased such as aprons, bottle openers, shirts, shoes, etc.

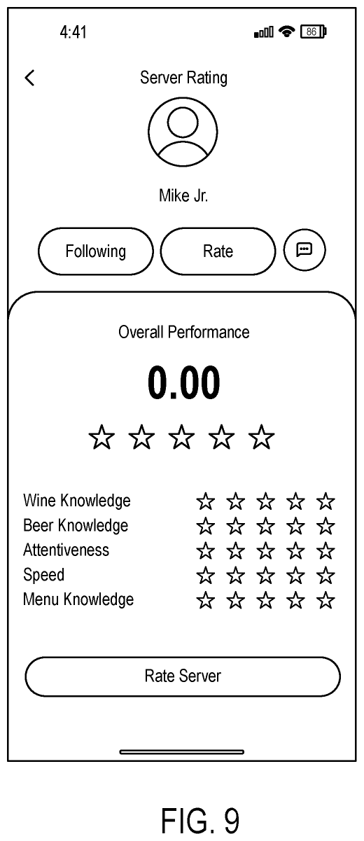

FIG. 9 illustrates an example ninth graphical user interface of the application, according to certain example embodiments. The ninth graphical user interface may be a server rating screen where a guest can rate the performance of the service provider. The guest may rate overall performance and specific performances. For example, a waiter may be reviewed on wine knowledge, beer knowledge, attentiveness, speed, and menu knowledge.

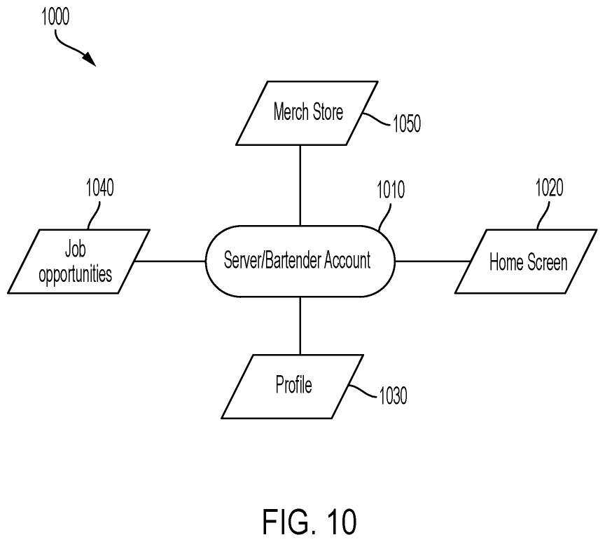

FIGS. 10-15 illustrate example flow diagrams. The flow diagrams include information which may be sent between one or more user devices and a computing device controlling the application. FIG. 10 illustrates an example flow chart 1000 for a service provider, according to certain example embodiments. The flow chart 1000 may include a service provider (e.g., a server/bartender) account 1010 from which a service provider may access a home screen 1020, a profile 1030, job opportunities 1040, and merchandise store 1050.

From the profile 1030, the service provider may access a list of regulars and may select and view details that the service provider has posted or messaged. The service provider may post or message content to individual regulars or to all regulars. From the profile 1030, the service provider may access a message board where the service provider may access public messages from other service providers that the service provider follows and may post public messages to all regulars. Also, from the profile 1030, the service provider may add work schedule information; for example, work hours, cut time (i.e., when no new customers will be served by the service provider), and clock out time.

From the job opportunities 1040, the service provider may see a list of nearby service locations that are hiring for similar positions. For example, a bartender may see where nearby bars and restaurants are hiring bartenders. From the job opportunities 1040, the service provider may reach out to new potential employers, view reviews from current and previous employees of the potential employers, and add reviews for previous or current employer of the service provider.

From the merchandise store 1050, the service provider may create and order one or more aprons with logos, pins, other items, and a QR code to link to the service provider's account on the application. From the merchandise store 1050, the service provider may also order other items such as wine keys, bottle openers, jeans, shoes, etc.

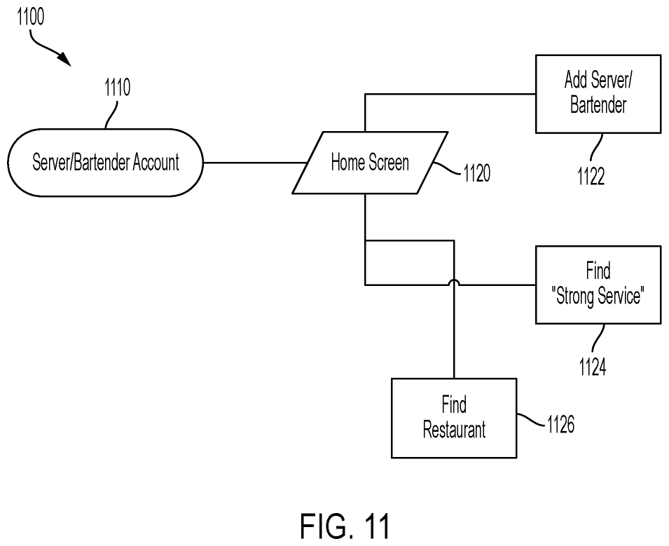

FIG. 11 illustrates another example flow chart 1100 for a service provider, according to certain example embodiments. From the home screen 1120, the service provider may add (e.g., follow) another service provider 1122, find other service providers (above a certain threshold; e.g., 4.2 stars out of 5 stars) 1124, and find service locations (e.g., restaurants) 1126. The adding another server provider 1122 may include searching for the other service provider and following the other service provider if the other service provider has an account/profile with the application. If the service provider does not have an account, the application may store the service provider's name and description. The service provider may provide a review for the other service provider.

The finding service 1124 may include the application displaying a list of local service providers with a profile meeting one or more thresholds. The thresholds may include a threshold for overall rating (average of all ratings). The overall ratings may be updated periodically. For example, reviews which are over a threshold period of time (e.g., 60 days or 90 days) may be deleted and may not be included in the overall rating on the profile of the service provider. The computing device managing the application may determine when a timestamp of a rating has exceeded the threshold time and may delete the rating and update the overall rating.

The finding restaurant 1126 may include displaying a map and showing, on the map, local service locations with service providers (with overall ratings above the threshold for service) who are currently working (e.g., clocked in). From the home screen 1120, the service provider may return to the service provider account 1110.

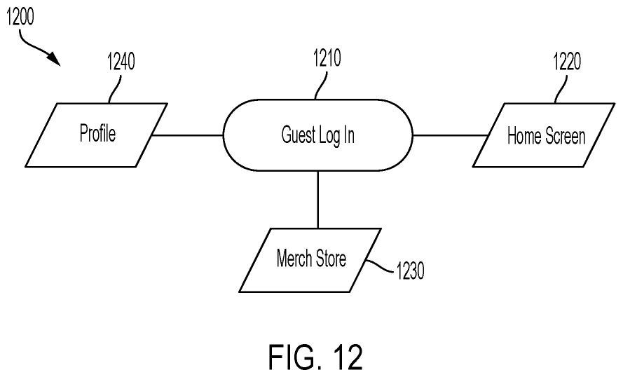

FIG. 12 illustrates an example flow chart 1200 for a guest, according to certain example embodiments. The flow chart 1200 may include a guest log in 1010 from which a guest may access a home screen 1220, a merchandise store 1230, and a profile 1240. From the merchandise store 1230 the guest can purchase merchandise from the service providers the guest follows. From the profile 1240, the guest may view a list of service providers the user follows and select service providers to view details that the service provider posts such as hours, specials, etc. From the profile 1240, the guest may access a message board and view public messages from service providers that the guest follows. Also from the profile 1240, the guest may view a list of favorite service locations and list of service providers on the clock at the service locations.

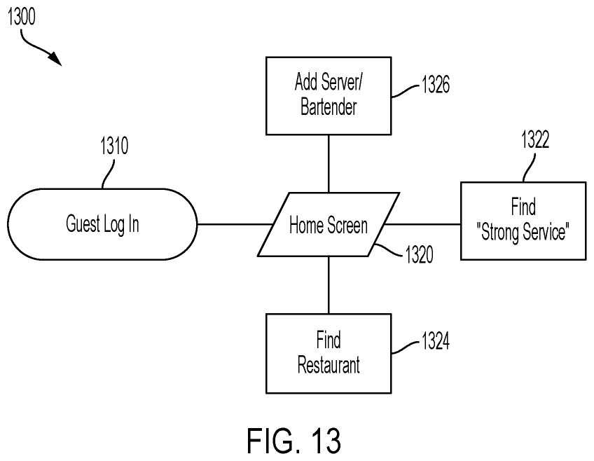

FIG. 13 illustrates another example flow chart 1300 for a guest, according to certain example embodiments. From the home screen 1320, the guest may add (e.g., follow) a service provider 1322, find service providers (service providers above a certain threshold; e.g., 4.2 stars out of 5) 1324, and find service locations (e.g., restaurants) 1326. The finding the service locations may include viewing a list of followed or linked service providers and displaying a map with service locations displayed with clocked in service providers that provide services. From the home screen 1320, the guest may return to the login 1310.

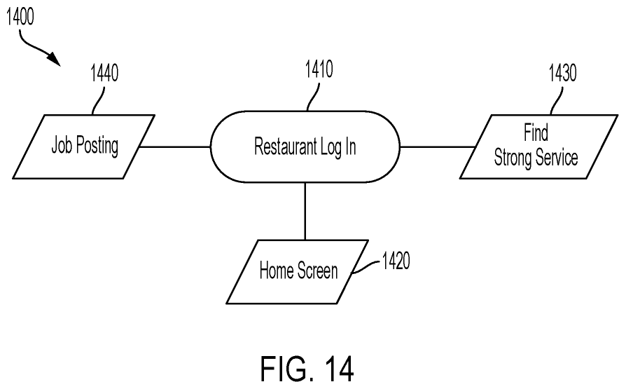

FIG. 14 illustrates an example flow chart 1400 for a service location, according to certain example embodiments. The flow chart 1400 may include a service location (e.g., a restaurant or shop) log in 1410 from which a representative of a service location may access a home screen 1420, find service 1430, and post job postings 1440. From the find service 1430, the representative of the service location may search for and find service providers looking for employment. The service providers may be searchable by job title. A list of service providers may be displayed. Individual service provider details including rating, number of followers, and current employment may also be displayed. Private messages may also be sent from the service location to the service provider seeking employment. From the job postings 1440, the representative of the service location may post public job postings seeking additional service providers (e.g., help wanted posting).

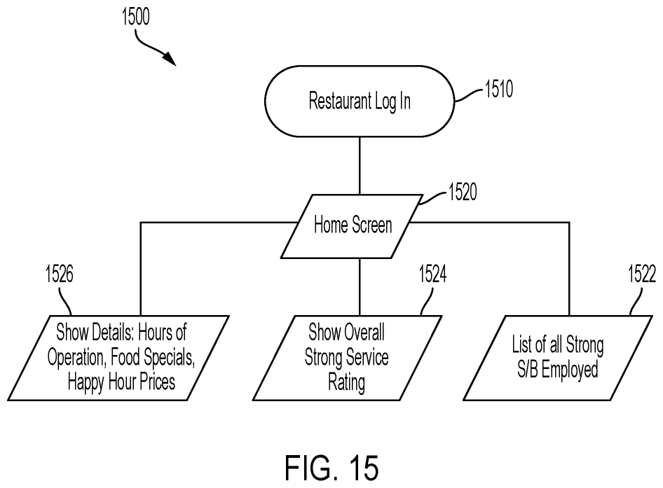

FIG. 15 illustrates another example flow chart 1500 for a service location, according to certain example embodiments. From the home screen 1520, the representative of the service location may view a list of all service providers employed by the service location 1522, show overall rating of service providers and the service provided at the service location 1524, and display details of operation including hours of operation, specials, deals, etc. 1526. From the home screen 1520, the representative of the service location may return to the login in 1510.

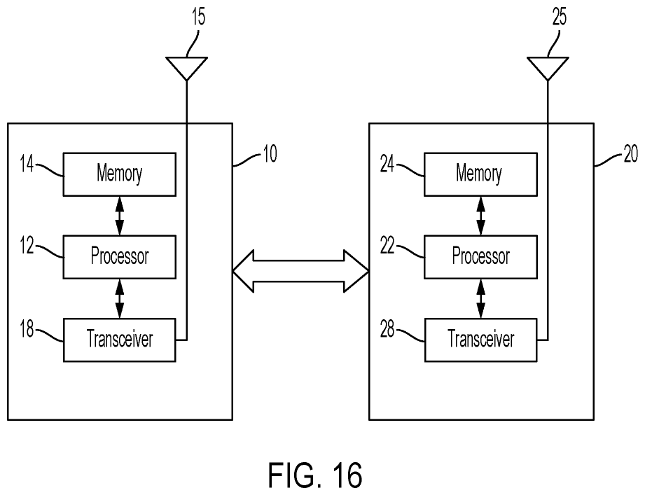

FIG. 16 illustrates a set of apparatuses, according to certain example embodiments. In certain example embodiments, apparatuses 10 and 20 may be elements in a network or associated with such a network. For example, apparatus 10 may be a user equipment (UE), and apparatus 20 may be a server managing the application.

In some example embodiments, apparatuses 10 and 20 may include one or more processors, one or more computer-readable storage medium (for example, memory, storage, or the like), one or more radio access components (for example, a modem, a transceiver, or the like), and/or a user interface. In some example embodiments, apparatuses 10 and 20 may be configured to operate using one or more radio access technologies, such as GSM, LTE, LTE-A, NR, 5G, 6G, 7G, WLAN, WiFi, NB-IoT, Bluetooth, NFC, MulteFire, and/or any other radio access technologies. It should be noted that one of ordinary skill in the art would understand that apparatuses 10 and 20 may include components or features not shown in FIG. 16.

As illustrated in the example of FIG. 16, apparatuses 10 and 20 may include or be coupled to a processors 12 and 22 for processing information and executing instructions or operations. Processors 12 and 22 may be any type of general or specific purpose processor. In fact, processors 12 and 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12, 22 is shown in FIG. 16, multiple processors may be utilized according to other example embodiments. For example, it should be understood that, in certain example embodiments, apparatuses 10 and 20 may include two or more processors that may form a multiprocessor system (e.g., in this case processors 12 may represent a multiprocessor) that may support multiprocessing. According to certain example embodiments, the multiprocessor system may be tightly coupled or loosely coupled (e.g., to form a computer cluster).

Processors 12 and 22 may perform functions associated with the operation of apparatuses 10 and 20 including, as some examples, forming a communication message, formatting of information, communicating information, storing information, and overall control of the apparatuses 10 and 20.

Apparatuses 10 and 20 may further include or be coupled to a memories 14 and 24 (internal or external), which may be respectively coupled to processors 12 and 24 for storing information and instructions that may be executed by processors 12 and 24. Memories 14 and 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memories 14 and 24 can be comprised of any combination of random access memory (RAM), read only memory (ROM), static storage such as a magnetic or optical disk, hard disk drive (HDD), or any other type of non-transitory machine or computer readable media. The instructions stored in memories 14 and 24 may include program instructions or computer program code that, when executed by processors 12 and 22, enable the apparatuses 10 and 20 to perform tasks as described herein.

In certain example embodiments, apparatuses 10 and 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 12 and 22 and/or apparatuses 10 and 20 to perform any of the methods and examples illustrated herein.

In some example embodiments, apparatuses 10 and 20 may also include or be coupled to one or more antennas 15 and 25 for receiving a downlink signal and for transmitting via an UL from apparatuses 10 and 20. Apparatuses 10 and 20 may each further include a transceiver 18 and 28 configured to transmit and receive information. The transceivers 18 and 28 may also include a radio interface (e.g., a modem) coupled to the antennas 15 and 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceivers 18 and 28 may be configured to modulate information on to a carrier waveform for transmission by the antennas 15 and 25 and demodulate information received via the antenna 15 and 25 for further processing by other elements of apparatuses 10 and 20. In other example embodiments, transceivers 18 and 28 may be capable of transmitting and receiving signals or data directly. Additionally or alternatively, in some example embodiments, apparatus 10 may include an input and/or output device (I/O device). In certain example embodiments, apparatuses 10 and 20 may further include a user interface, such as a graphical user interface or touchscreen.

In certain example embodiments, memories 14 and 34 store software modules that provide functionality when executed by processors 12 and 22. The modules may include, for example, an operating system that provides operating system functionality for apparatuses 10 and 20. The memory may also store one or more functional modules, such as an application or program, to provide additional functionality for apparatuses 10 and 20. The components of apparatuses 10 and 20 may be implemented in hardware, or as any suitable combination of hardware and software. According to certain example embodiments, apparatuses 10 and 20 may optionally be configured to communicate with each other (in any combination) via a wireless or wired communication links 70 according to any radio access technology, such as NR.

According to certain example embodiments, processors 12 and 22 and memories 14 and 24 may be included in or may form a part of processing circuitry or control circuitry. In addition, in some example embodiments, transceivers 18 and 28 may be included in or may form a part of transceiver circuitry.

The apparatus 10 may be an example of a first user device. The apparatus 20 may be an example of a computing device managing an application. The computing device may communicate with many user devices to manage the application. For example, the computing device may receive inputs such as profile information, messages, location information (e.g., global positioning system data), job posting information, etc. from user devices and store and organize the information for use in the application. The computing device may also provide information to the user devices such as service locations, service provider information, profile information for the user's own profile or the profiles of others, location information for service providers and service locations, job posting information, etc. Messages sent between users may be received by the computing device and sent to the intended receiving user device via the application. The computing device may also determine recommendations based on the user's data and provide recommendations to the user. For example, the computing device may send a recommendation to the first user device of an Italian restaurant with service providers on the clock with high overall ratings based on the user data showing that the user frequently dines at Italian restaurants. Also, the computing device may notify the user device when a service provider, for whom the user is a regular, has clocked in and recommend going to the service location of the service provider.

The application may be free or a paid service. The application may have different types of accounts and users. For example, the application may include service providers, customers (guests), and service locations (stores, shops, bars, etc.). A user can search for a service provider or service location on the application. If the service provider or the service location does not have an account, the application may prompt the guest to enter and store the service location's name and the service provider's name so the guest can request the provider the next time they visit the service location. The service provider can also enter information into the application indicating that the service provider is seeking employment at a new service location. The computing device may receive the ratings entered into the application from the user devices and may calculate an overall rating for each service provider based on the individual ratings. The overall rating may be sent to the user devices from the computing device via the application. Ratings for different categories may also be stored and may be sent by the computing device to the user devices via the application.

The computing device via the application may provide users (guests and service providers) with awards such as virtual pins on their profile for placing reviews and using the application. Users of the application may also provide awards to other users via the application and the computing device. For example, guests may provide awards to service providers for good service. Guests may send a request to follow a service provider, via the application, to the computing device. The computing device may determine when a service provider has achieved a predetermined service status by having an overall rating above a threshold value and may provide a predetermined service pin or other indication in the profile of the service provider. The computing device may update the profile of the guest and the service provider based on the request and provide recommendations based on the request and the status of the guest following the service provider. The computing device may notify customers who follow a service provider and/or are regulars of the service provider when the service provider via a user device updates their profile to show that the service provider is working at a different service location (e.g., the computing device received the updated information from the user device of the service provider). Service providers may send information such as check in, clock in, clock out, information to the computing device through the application. The computing application may receive and then send this information to user devices of the guests that follow the service provider through the application.

The computing device may also provide advertisements to guests in the application based on the guest's data in the application. The computing device may also manage the merchandise store and provide the information related to the merchandise store to the user devices. The computing device may communicate with user devices associated with representatives of service locations to communicate user traffic information. This service may be a paid service. Service provider's accounts and service location accounts for a service location that employ the service provider may be linked (e.g., certain parts of the service provider's account not publicly available may be visible to the service location account). Also, the service location accounts may provide information which the computing device will display on the account of the service provider, such as deals, events, and promotions at the service location. This information may be sent to user devices associated with regulars of the service provider as well. The computing device may also host job postings received from user devices of service locations and facilitate communications between service providers and service locations related to potential employment via the application.

Service providers may enter information about their appearance, such as a photo or description to make them more recognizable, into the application. The computing device may store the information and send the information to computing device when requests to view the service provider's profile are received from a user device. The computing device may create a unique QR code for the service provider that customers may scan to link accounts (e.g., follow).

Guests may send information to be included in their profile including a picture, general personal information, and service providers they follow. The information may be received and stored by the computing device. The computing device may provide the information to users when a request to view the guest's profile is received. The guests may also enter information about service providers, such as a favorite drink that a bartender makes, which the computing device may place in the profile of the service provider. The computing device may also provide awards (such as pins) on the profiles of the guests and service providers when criteria for the awards are met. Pins may expire after a threshold amount of time and be removed from the profile by the computing device.

Service providers may send information to be included in their profile including a picture, or general personal information. The information may be received and stored by the computing device. The computing device may provide the information to users when a request to view the service provider's profile is received. The service providers may enter schedule information (for a current workday, a typical workday, a weekly schedule, etc.) which can be shared by the computing device with regulars or anyone that views their profile. The service provider may also use the application to enter a clock in time, cut time, and clock out time as each occurs. The service providers may also send messages to guests that follow the service provider using the application and via the computing device. Service providers may include images, such as pictures of daily specials or event promotions in the messages. The messages may be received by the computing device and sent to the intended recipients.

The computing device may receive the ratings from the guests, calculate an overall rating, and provide overall rating to guests based on the received ratings. Service providers with an overall rating above a threshold (such as 4.2 stars out of 5 stars) may be determined by the computing device as providing services and give the label of “strong service” in the application, where “strong service” indicates a reliable and/or efficient server. Such a “strong server” can be desirable by both customer and employers. Service providers providing strong services may be promoted by the application (e.g., only service providers with a rating indicating strong service will be recommended to guests). A service provider may input a request to remain hidden or not be recommended so that the computing device does not send recommendations for the service provider. For example, if a service provider is not accepting new customers the service provider may request to remain hidden on the application until the service provider is ready to accept new customers.

The ratings from guests may be temporary. The computing device may determine if a rating is over a threshold age (e.g., 60, or 90 days) and delete the rating and recalculate the overall rating of the service provider without the deleted rating. In this way the service rating may be up to date and reflect the current level of service being provided by the service provider. Alternatively, the rating may be maintained in the application as a backlog rating and may only be excluded from the overall rating calculation.

Guests may search an area (an area around their device's location, or a selected area), the search results provided by the computing device may only include service providers with strong service ratings or may highlight service providers with strong service ratings. The computing device may receive the search query and provide a search result to the user device. A service provider with a strong service rating may be displayed as a profile card on a map. The profile card may include the service provider's name, service location, picture, overall rating, and pins and badges. If the guest selects the profile card, the computing device may send information for the user device of the guest to display the full profile of the service provider. The guest may also select to follow the service provider. The search may be performed based on search terms such as service location type (e.g., restaurant, bar, hair salon). A card for a service location may appear on a map displayed on the user device and the guest may select the service location and view the profile of the service location. Service location profiles may have links to websites of the respective service providers. The service location profiles may include service information, such as hours of operation, on the clock service providers, prices, specials, etc. The computing device may also provide information beyond what is included in the profile of the service location or service provider such as distance from a service location to the user device and service location type (e.g., Italian restaurant, nail salon, etc.). Results from searches and recommendations may be provided based on the distance between the service location and the user device. For example, a threshold distance may be used to exclude service locations. The computing device may receive a search query and provide a list of service providers at service locations within the threshold distance from the user device.

The computing device may send notification to user devices based on updates from service providers followed by the guest. For example, if a service provider that the guest follows clocks in or out, notifications may be sent to the user device. As another example, if the service provider changes employment such that services are provided at a different service location, a notification may be sent to the guests that follow the service provider. Notifications related to services, such as notifications of specials or events, may also be provided to the guests that follow a service provider of a service location with these services. The profile of the service provider may also have features for guests to reserve services (e.g. reserve a table at a restaurant) through a calendar, sign up sheet, or other similar feature.

The computing device may also have an interface for an administrator to input information and receive analytic reports for operation of the application. The computing device may store information related to users, such as movement information, number of unique users, number of daily active users, popularity of search terms, and other analytic data. A service of the application may include sharing analytic data with service location profiles.

The application as implemented by the computing device provides improvements in computer-related technology. The application connects service providers and clientele (e.g., guests) in an unprecedented way. The service providers can communicate automatically to guests following the service provider when the service provider has clocked in, where the service provider is providing services, and when the service provider clocks out. The application also allows for recommendations to be made to guests based on the quality of the service provided by the service provider and the distance the guest is to the service location of the service provider. The quality of the service provided by the service provider may be determined based on reviews from guests (e.g., by averaging reviews from guests). The service provider also may have control over the publicity of their profile. The service provider may make their profile public when additional guests to serve are desired and private when additional guests to serve are not desired. A profile for a service location may also allow for guests to reserve services (e.g. reserve a table at a restaurant). The combination of these features requires a computing device to provide communication and recommendations to guests and service providers that improves the communication between service providers and clientele and also provides improvements in computer-related technology.

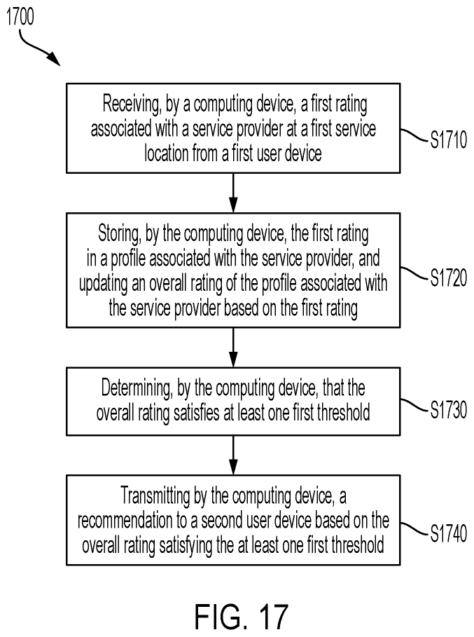

FIG. 17 illustrates an example flow chart of operations performed by a computing device including, at S1710, receiving, by a computing device, a first rating associated with a service provider at a first service location from a first user device, at S1720, storing, by the computing device, the first rating in a profile associated with the service provider, and updating an overall rating of the profile associated with the service provider based on the first rating, at S1730, determining, by the computing device, that the overall rating satisfies at least one first threshold, and at S1740, transmitting by the computing device, a recommendation to a second user device based on the overall rating satisfying the at least one first threshold.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with procedures in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments.

We claim:

1. A method comprising:
receiving, by a computing device, a first rating associated with a service provider at a first service location from a first user device;
storing, by the computing device, the first rating in a profile associated with the service provider;
updating, by the computing device, an overall rating of the profile associated with the service provider based on the first rating;
determining, by the computing device, that the overall rating satisfies at least one first threshold; and
transmitting, by the computing device, a recommendation to a second user device based on the overall rating satisfying the at least one first threshold.

2. The method of claim 1 further comprising:
determining, by the computing device, that a timestamp of the first rating has exceeded a predetermined threshold period of time; and
removing, by the computing device, the first rating from the overall rating based on the timestamp of the first rating having exceeded the predetermined threshold period of time and updating the overall rating of the profile associated with the service provider based on the first rating being deleted.

3. The method of claim 1 further comprising:
receiving, by the computing device, a request for service providers from the second computing device associated with a location of the second computing device;
determining, by the computing device, at least one service provider profile associated with the location of the second computing device that satisfies a threshold rating; and
transmitting, to the second computing device, a list of service provider profiles.

4. The method of claim 3 wherein the list of service provider profiles further comprises associated service locations for each respective service provider profile.

5. The method of claim 1 further comprising:
receiving, by the computing device, a second rating associated with the service provider at a second service location from the first user device or a third user device; and
storing, by the computing device, the second rating in the profile associated with the service provider and updating the overall rating of the profile associated with the service provider based on the second rating.

6. The method of claim 1 further comprising:
receiving, by the computing device, a request to receive notifications related to the service provider from the first user device; and
sending, a notification to the first user device relating to the service provider.

7. The method of claim 6, wherein the notification comprises a status of the service provider.

8. The method of claim 6, wherein the status comprises a change from the first service location to a second service location for the service provider.

9. The method of claim 6, wherein the notification further comprises information related to services available at the first service location.

10. The method of claim 1, further comprising:
determining, by the computing device, that the overall rating satisfies at least one second threshold; and
providing, by the computing device, an indication in the profile of the service provider based on the overall rating satisfying the at least one second threshold.

11. An apparatus comprising:
at least one processor; and
at least one memory comprising computer program code,
the at least one memory and the computer program code are configured, with the at least one processor, to cause the apparatus at least to
receive a first rating associated with a service provider at a first service location from a first user device;
store the first rating in a profile associated with the service provider;
update an overall rating of the profile associated with the service provider based on the first rating;
determine that the overall rating satisfies at least one first threshold; and
transmit a recommendation to a second user device based on the overall rating satisfying the at least one first threshold.

12. The apparatus of claim 11 wherein the at least one memory and the computer program code are configured, with the at least one processor, to cause the apparatus to further:
determine that a timestamp of the first rating has exceeded a predetermined threshold period of time; and
remove the first rating from the overall rating based on the timestamp of the first rating having exceeded the predetermined threshold period of time and updating the overall rating of the profile associated with the service provider based on the first rating being deleted.

13. The apparatus of claim 11 wherein the at least one memory and the computer program code are configured, with the at least one processor, to cause the apparatus to further:
receive a request for service providers from the second computing device associated with a location of the second computing device;
determine at least one service provider profile associated with the location of the second computing device that satisfies a threshold rating; and
transmit, the second computing device, a list of service provider profiles.

14. The apparatus of claim 13 wherein the list of service provider profiles further comprises associated service locations for each respective service provider profile.

15. The apparatus of claim 11 wherein the at least one memory and the computer program code are configured, with the at least one processor, to cause the apparatus to further:
receive a second rating associated with the service provider at a second service location from the first user device or a third user device; and
store the second rating in the profile associated with the service provider and updating the overall rating of the profile associated with the service provider based on the second rating.

16. The apparatus of claim 11 further comprising:
receive a request to receive notifications related to the service provider from the first user device; and
send a notification to the first user device relating to the service provider.

17. The apparatus of claim 16, wherein the notification comprises a status of the service provider.

18. The apparatus of claim 16, wherein the status comprises a change from the first service location to a second service location for the service provider.

19. The apparatus of claim 11, wherein the at least one memory and the computer program code are configured, with the at least one processor, to cause the apparatus to further:
determine that the overall rating satisfies at least one second threshold; and
provide an indication in the profile of the service provider based on the overall rating satisfying the at least one second threshold.

20. A non-transitory computer readable medium comprising program instructions stored thereon that, when executed by an apparatus, cause the apparatus to perform at least:
receiving a first rating associated with a service provider at a first service location from a first user device;
storing the first rating in a profile associated with the service provider;
updating an overall rating of the profile associated with the service provider based on the first rating;
determining that the overall rating satisfies at least one first threshold; and
transmitting a recommendation to a second user device based on the overall rating satisfying the at least one first threshold.
